(19) United States
(12) Patent Application Publication
(10) Pub. No.: US 2016/0193695 A1
(43) Pub. Date: Jul. 7, 2016

(54) SOLID AXISYMMETRIC POWDER BED FOR SELECTIVE LASER MELTING

(71) Applicant: AEROJET ROCKETDYNE OF DE, INC., Canoga Park, CA (US)

(72) Inventor: Jeffrey D. HAYNES, Stuart, FL (US)

(73) Assignee: AEROJET ROCKETDYNE OF DE, INC., Canoga Park, CA (US)

(21) Appl. No.: 14/787,826

(22) PCT Filed: Mar. 5, 2013
(86) PCT No.: PCT/US13/29141

§ 371 Date: Oct. 29, 2015

Related U.S. Application Data
(63) Continuation of application No. 61/676,451, filed on Jul. 27, 2012.

(51) Int. Cl. B23K 26/342; B23K 26/06; B23K 26/144; B23K 26/32

(52) U.S. Cl. CPC B23K 26/342; B23K 26/32; B23K 26/0604; B23K 26/144; B33Y 10/00

(57) ABSTRACT

A Selective Laser Melting (SLM) system includes an annular powder bed.

The present disclosure claims priority to U.S. Provisional Patent Disclosure Ser. No. 61/676,451 filed Jul. 27, 2012.

### BACKGROUND

The present disclosure relates generally to additive manufacturing applications.

Selective laser melting (SLM) is an additive manufacturing process that uses 3D CAD data as a digital information source and energy in the form of a high powered laser beam (usually an ytterbium fiber laser) to form three-dimensional metal parts by fusing fine metallic powders.

Selective laser melting (SLM) machines typically operate with a rectilinear powder bed build chamber of about 15 inches (381 mm) in X, Y and Z dimension. The types of materials that can be processed include stainless steel, tool steel, cobalt chrome, titanium, nickel, aluminum and others in atomized powder material form.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a general schematic view of an exemplary Selective Laser Melting (SLM) system according to one disclosed non-liming embodiment;

FIG. 2 is a phantom lateral view of an annular powder bed according to one disclosed non-liming embodiment for a Selective Laser Melting (SLM) system;

FIG. 3 is a phantom lateral view of an annular powder bed according to one disclosed non-liming embodiment for a Selective Laser Melting (SLM) system;

FIG. 4 is a schematic perspective view of an axisymmetric component manufactured by an exemplary Selective Laser Melting (SLM) system with an annular powder bed of FIG. 2;

FIG. 5 is a schematic perspective view of an axisymmetric component manufactured by an exemplary Selective Laser Melting (SLM) system with an annular powder bed of FIG. 3; and

FIG. 6 is a general schematic view of an exemplary Selective Laser Melting (SLM) system according to another disclosed non-liming embodiment;

### DETAILED DESCRIPTION

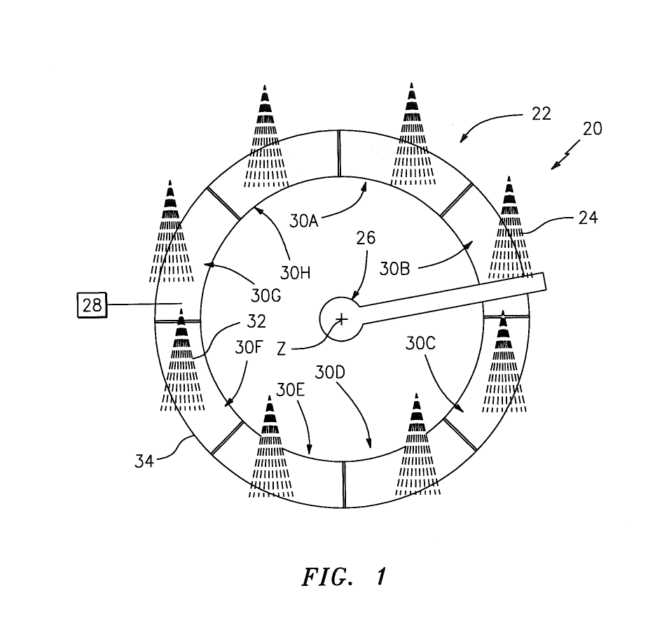

FIG. 1 schematically illustrates a Selective Laser Melting (SLM) system 20 that may have particular applicability to axisymmetric components such as gas turbine engine cases, combustors, rocket nozzles and other such annular, ring, cylindrical frustro-contical and conical components of a relatively significant diameter. The system 20 includes a generally annular powder bed 22, one or more lasers 24, a re-coater blade 26 and a control 28. It should be appreciated that various components and subsystems may additionally or alternatively provided.

The generally annular powder bed 22 is defined by a multiple of build chambers 30A-30n arranged in a circular pattern. Each build chamber 30A-30n is closed off hermetically and includes an inlet and an outlet for an inert gas which is intended to avoid unwanted reactions of the melt bath as well as a window through which the a laser beam from the one or more lasers 24 may pass.

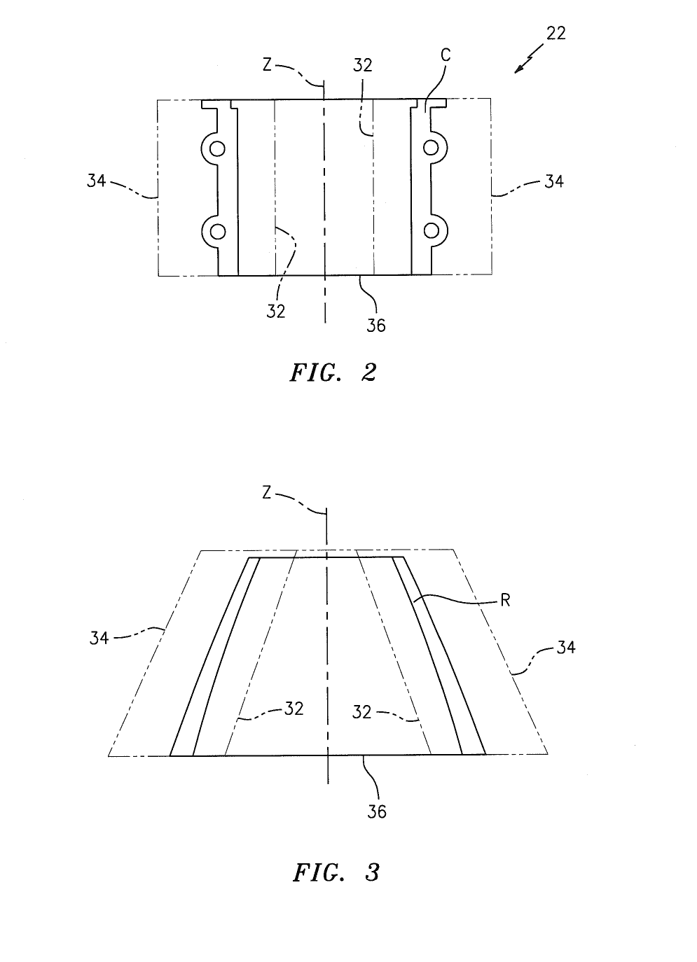

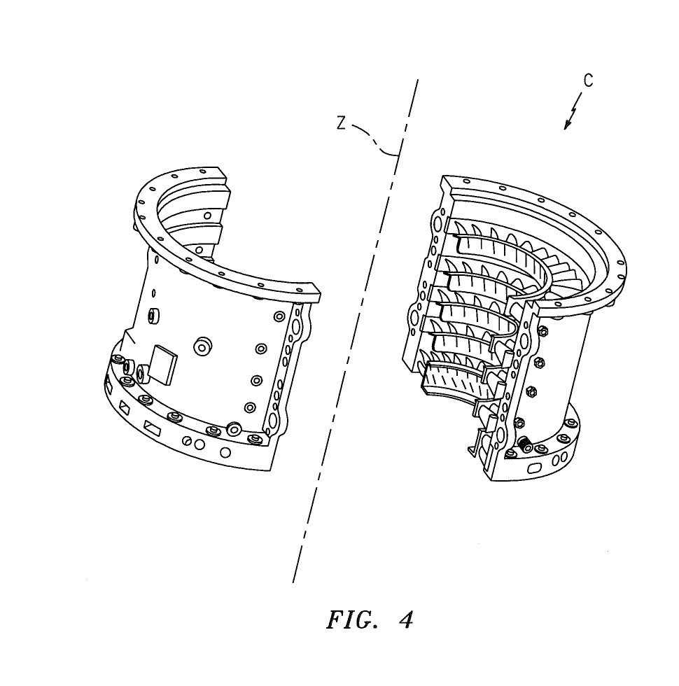

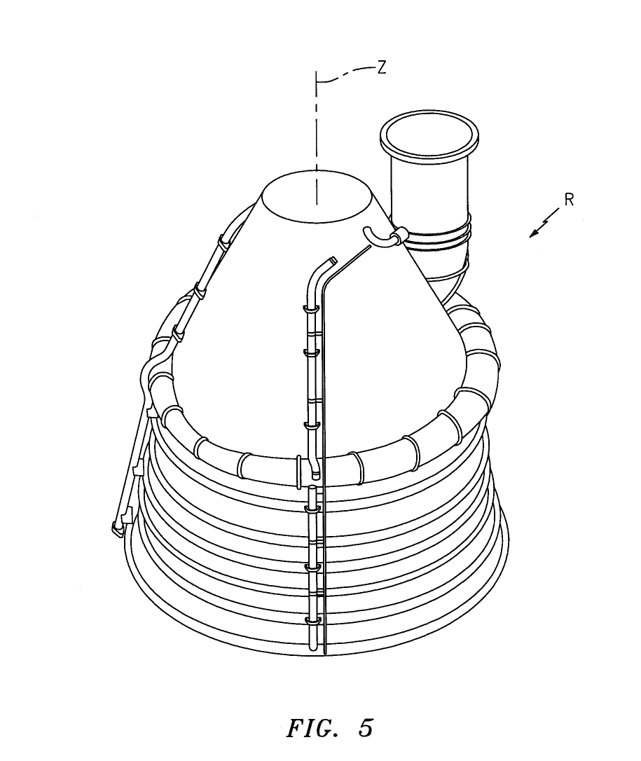

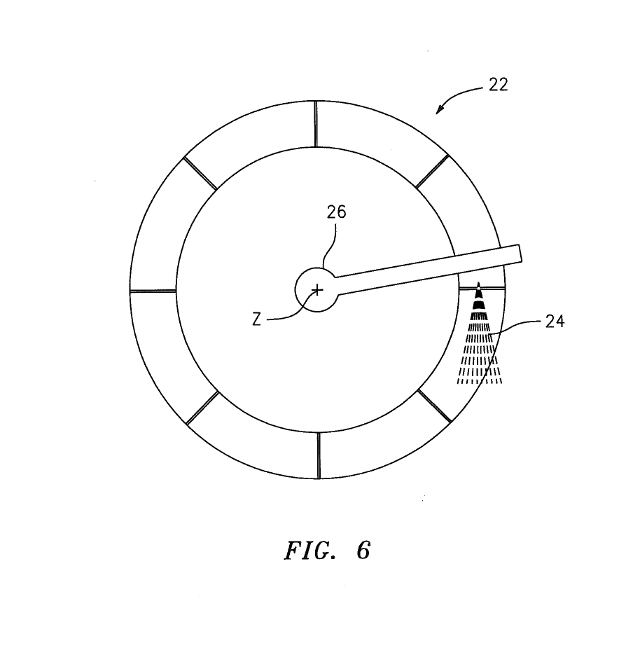

Each build chamber 30A-30n may include a curved inner wall 32 and a curved outer wall 34. The curved inner and outer wall 32, 34 may be perpendicular with respect to a base 36 (Z-axis; FIG. 2) to facilitate manufacture of generally cylindrical components such as a gas turbine engine case C (FIG. 4). Alternatively, the curved inner and outer wall 32, 34 may be angled with respect to the base 36 (FIG. 3) to facilitate manufacture of generally conical components such as a rocket nozzle R (FIG. 5). Moreover, various diameters of the generally conical build chamber 22 (FIG. 3) may be utilized to form frustro-conical sections of a component which are later assembled along a Z-axis to form a complete component, for example, the rocket nozzle R (FIG. 5).

The base 36 of the generally annular powder bed 22 may be lowered so that the axisymmetric component can be produced in a stock of powder, while, in each case after a ply of the axisymmetric components has been produced by the one or more lasers 24, the base 36 is lowered by the amount of the thickness of the ply. Alternatively, the one or more lasers 24, and the re-coater blade 26 are raised with respect to the axisymmetric component while the base 36 remains fixed. Alternatively still, the annular powder bed 22 and/or the base 36 is rotated about the central axis Z while the one or more lasers 24 and the re-coater blade 26 are rotationally stationary. It should be understood that various combinations thereof may be provided to facilitate manufacture.

In one disclosed non-limiting embodiment, one or more lasers 24 are associated with each of the multiple of build chambers 30A-30n. At least one of the one or more lasers 24 associated with each of the multiple of build chambers 30A-30n may partially overlap with an associated one of the multiple of build chambers 30A-30n to assure continuity.

In another disclosed non-limiting embodiment of a Selective Laser Melting (SLM) system 20′, one or more lasers 24 are mounted to the re-coater blade 26 for rotation therewith (FIG. 6). That is, leveling of the powder by the re-coater blade 26 as well as laser beam processing is rotationally achieved.

In operation according to one disclosed non-limiting embodiment the metallic material powder is distributed in response to the control 28 by rotation of the re-coater blade 26 abut the central axis Z over a reservoir of the material powder (not shown) and the annular powder bed 22. After the one or more lasers 24 have processed each layer, the re-coater blade 26 distributes fresh material powder over the axisymmetric component, which may be lowered so as to correspond to the layer thickness that is to be next applied. However, the layer that has been processed by the one or more lasers 24 may not be completely smooth and in some cases may be greater than the layer thickness to be applied. At these points, the re-coater blade 26 also grinds over the layer that was last processed during application of the new layer of material powder to facilitate continuation of the process.

The annular powder bed 22 facilitates an efficient, large axisymmetric build envelope for axisymmetric components with reduced residual stress.

It should be understood that like reference numerals identify corresponding or similar elements throughout the several drawings. It should also be understood that although a particular component arrangement is disclosed in the illustrated embodiment, other arrangements will benefit herefrom.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The use of the terms “a” and “an” and “the” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A Selective Laser Melting (SLM) system comprising:
an annular powder bed.

2. The system as recited in claim 1, wherein said annular powder bed is cylindrical.

3. The system as recited in claim 1, wherein said annular powder bed is frustro-conical.

4. The system as recited in claim 1, wherein said annular powder bed is defined by a multiple of build chambers arranged in a circular pattern.

5. The system as recited in claim 1, wherein each of said multiple of build chambers include a curved inner wall and a curved outer wall.

6. The system as recited in claim 5, wherein said curved inner wall and said curved outer wall are perpendicular to a base.

7. The system as recited in claim 5, wherein said curved inner wall and said curved outer wall are angled with respect to a base.

8. The system as recited in claim 1, further comprising a multiple of lasers.

9. The system as recited in claim 8, wherein said annular powder bed is defined by a multiple of build chambers, each of said multiple of build chambers associated with at least one of said multiple of lasers.

10. The system as recited in claim 1, further comprising a re-coater blade rotatable about an axis about which said annular powder bed is defined.

11. The system as recited in claim 10, further comprising at least one laser mounted to said re-coater blade.

12. A Selective Laser Melting (SLM) system comprising:
a multiple of build chambers arranged in a circular pattern.

13. The system as recited in claim 12, wherein each of said multiple of build chambers include a curved inner wall and a curved outer wall.

14. The system as recited in claim 13, wherein said curved inner wall and said curved outer wall are perpendicular to a base.

15. The system as recited in claim 13, wherein said curved inner wall and said curved outer wall are angled with respect to a base.

16. A method of additive manufacturing comprising:
manufacturing an axis-symmetric component within an annular powder bed.

17. The method as recited in claim 16, further comprising arranging a multiple of build chambers in a circular pattern to define the annular powder bed.

18. The method as recited in claim 17, associating at least one laser with each of the multiple of build chambers.

19. The method as recited in claim 16, further comprising rotating a re-coater blade around an axis about which said annular powder bed is defined.

20. The method as recited in claim 16, mounting at least one laser to the re-coater blade.
